(19) United States
(12) Patent Application Publication
(10) Pub. No.: US 2014/0013970 A1
(43) Pub. Date: Jan. 16, 2014

(54) VOLUMETRIC BALING RATE MONITOR FOR ROUND BALER

(71) Applicant: AGCO Corporation, Duluth, GA (US)

(72) Inventor: Brian D. Olander, Buhler, KS (US)

(21) Appl. No.: 13/942,999

(22) Filed: Jul. 16, 2013

Related U.S. Application Data
(60) Provisional application No. 61/672,067, filed on Jul. 16, 2012.

(51) Int. Cl. A01F 15/08; A01F 15/07

(52) U.S. Cl. CPC A01F 15/0833; A01F 15/07
USPC 100/88; 100/99

(57) ABSTRACT

A round baler for use in baling crops has a bale forming mechanism that forms a bale in a baling chamber of the round baler and a volumetric baling rate monitor that measures and displays the amount of crop material taken in by the round baler. The volumetric baling rate monitor includes a bale size sensor that generates a signal representative of a measured size of the bale in the baling chamber and a controller that receives the bale size signal from the bale size sensor over a desired period of time and calculates a volumetric baling rate from an increase in the measured size of the bale in the baling chamber over the period of time. The volumetric baling rate monitor also includes a user interface that displays the volumetric baling rate of the baler.

### CROSS REFERENCE TO RELATED APPLICATIONS

This application claims priority to U.S. Provisional Application No. 61/672,067 filed Jul. 16, 2012, entitled “VOLUMETRIC BALING RATE MONITOR FOR ROUND BALER”.

### BACKGROUND OF THE INVENTION

1. Field of Invention

This invention relates to balers and more particularly, to a volumetric baling rate monitor for round balers.

2. Description of Related Art

Conventional round balers pick-up crop from a windrow and form it into compacted bales in a bale forming chamber. When a bale reaches a desired size and/or shape, sensors signal a controller that subsequently sends a signal to user interface such as an operator's panel to instruct the operator to stop forward motion of the baler so that a bale wrapping operation can be performed. Once a bale has been formed and wrapped, it is ejected from the baler so a new bale can be formed and wrapped.

The amount of cut crop in a windrow to be baled can be affected by many environmental factors, and thus the size of the crop windrow to be picked up by the round baler may not be uniform across the field. The amount of crop material in a windrow is typically the major factor in determining the optimum ground speed of a round baler to achieve maximum productivity and desired bale density. It is difficult and tiresome for the baler operator to visually judge the amount of material in the windrow and increase or decrease the ground speed of the baler accordingly.

Therefore, there is a need to provide appropriate information to the operator to monitor the volumetric baling rate that overcomes the limitations of the prior art.

### OVERVIEW OF THE INVENTION

In one embodiment, the invention is directed to a round baler for use in baling crops. The round baler includes a bale forming mechanism that forms a bale in a baling chamber of the round baler and a volumetric baling rate monitor that measures and displays the amount of crop material taken in by the round baler. The volumetric baling rate monitor includes a bale size sensor that generates a signal representative of a measured size of the bale in the baling chamber and a controller that receives the bale size signal from the bale size sensor over a desired period of time and calculates a volumetric baling rate from an increase in the measured size of the bale in the baling chamber over the period of time. The volumetric baling rate monitor also includes a user interface that displays the volumetric baling rate of the baler. The bale-forming mechanism may include at least one bale-forming belt and at least one belt tensioning arm configured to maintain tension in the bale-forming belt with the bale size sensor connected to the belt tensioning arm. In one embodiment, the bale size sensor is coaxially mounted to a mounting shaft of the belt tensioning arm and produces an output signal corresponding to the rotational position of the belt tensioning arm, which position is representative of the size of a bale being formed within the baling chamber.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic, side elevational illustration of a round baler with a near sidewall thereof removed to reveal mechanisms within the baler; and

FIG. 2 is a schematic illustration of a volumetric baling rate monitor of the round baler of FIG. 1.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

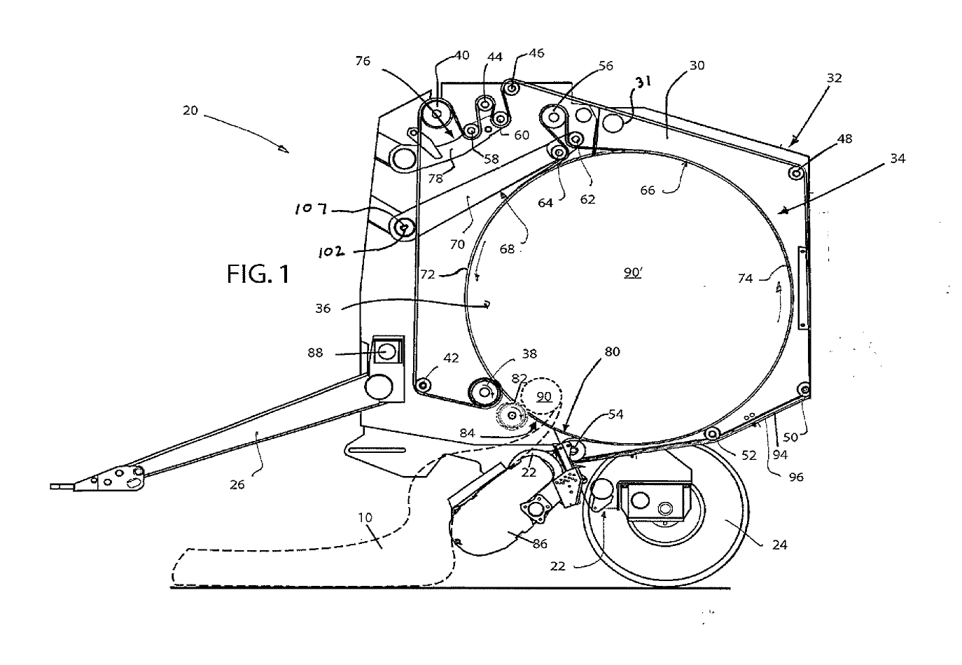

Turning to the figures, FIG. 1 shows a round baler 20 for use in baling crops. The baler 20 may include a chassis 22 that is supported for travel by a pair of ground engaging wheels 24 (only one wheel being shown in the drawing figures). A tongue 26 projects forwardly from the chassis 22 for connection with a towing vehicle (not shown). It is noted that directional references, such as up/down, front/rear or left/right orientation, are for informational purposes with reference to the particular figures in the disclosure and are not meant as limitations on the invention. The directional references of the baler 20 and the baler components of FIG. 1 are made from the reference point of standing behind the baler 20 and looking forward in the direction of travel. The chassis 22 may carry a pair of upright, laterally spaced sidewalls 30 (only one wall being shown in the drawing figures) that cooperate to define a space within which bale-forming and bale wrapping operations may be carried out as the baler 20 is advanced across a field.

The sidewalls 30 may present stationary forward portions fixed to the chassis 22 and rearward portions swingably attached to forward portions at an elevated pivot 31 as is customary in the art. Rearward portions of the sidewalls 30 may cooperatively define a tailgate 32 that is swingable between an open discharge position (not shown), in which the tailgate 32 is sufficiently raised to allow a completely formed bale to be discharged from the baler 20, and a closed baling position (FIG. 1), in which the bale-forming and wrapping operations are performed.

As is known in the art, the baler 20 includes a bale-forming mechanism 34 that comprises a number of rolls and belts that cooperate with the sidewalls 30 to define an internal baling chamber 36 that assumes different shapes and sizes throughout the bale-forming cycle. In one embodiment of bale-forming mechanism 34 as illustrated in FIG. 1, baler 20 comprises a plurality of laterally extending, stationary rolls, including a lower drive roll 38, an upper drive roll 40, and a plurality of idler rolls 42, 44, 46, 48, 50, 52, 54, 56, 58, 60, 62, and 64. It is noted that a subset of the idler rolls 42-56 are stationary with respect to their position relative to the baler chassis 22, while another subset of the idler rolls 58-64 may be mounted to a swingable structure. Stationary rolls 42-56 are arranged between the sidewalls 30 in a generally circular pattern (when viewed from the left side shown in FIG. 1) for guiding a plurality of laterally spaced continuous belts 66 as the belts 66 are driven linearly during bale formation and wrapping. While the bale-forming mechanism 34 of the depicted embodiment is made up of idler rolls 42-64 and a plurality of belts 66, alternative baling forming mechanisms with a single belt or different idler roll configurations could alternatively be used in a baler as will be understood by one of ordinary skill in the art, without departing from the teachings of the present invention. Additionally, it is contemplated that the belts 66 may be formed using a roller chain with slats. It is also noted that additional rolls, such as trash clearing rolls or offsetting rolls could be incorporated into the bale-forming mechanism 34 without departing from the teachings of the present invention.

In the illustrated embodiment, the bale-forming mechanism 34 further includes a belt guiding or retaining assembly 68 having a pair of vertically swingable tensioning arms 70 (with only the right arm being shown in FIG. 1) located inside the baler 20 adjacent the sidewalls 30. The tensioning arms 70 support a pair of idler rolls 62, 64 in a position to directly overlie the bale during its formation within baling chamber 36. In addition, the tensioning arms 70 are yieldably biased downwardly so that rolls 62, 64 exert pressure against the top of the bale as it is being formed. It will be noted that belts 66 wrap under lower drive roll 38, over relatively large idler roll 56, and under idler roll 54 to present a pair of opposed, front and rear belt stretches 72, 74 that cooperate with sidewalls 30 to define the baling chamber 36.

The belts 66 are confined between retaining idler rolls 62, 64, and extend upwardly therefrom to wrap around relatively large idler roll 56, whereby vertical belt stretches 72, 74 converge toward one another as idler rolls 62, 64 are approached. Although not illustrated in detail, it will be appreciated by one of ordinary skill in the art that the baling chamber 36 consequently initially assumes a generally vertical, triangular configuration when baling chamber 36 is empty and tensioning arms 70 are in their lowermost position. When drive rolls 38 and 40 are rotated in a clockwise direction (as oriented in the illustration of FIG. 1), front belt stretch 72 moves in a downward direction, while rear belt stretch 74 moves in an upward direction, when baling chamber 36 is empty at the beginning of a new bale-forming cycle.

A slack control arm assembly 76 located in the upper front portion of baler 20 includes a pair of vertically swingable arms 78 (with only the right arm being shown in FIG. 1). Arms 78 support the other pair of movable idler rolls 58, 60. As will be readily appreciated by one of ordinary skill in the art upon review of this disclosure, slack control assembly 76 controls the amount of slack paid out to belts 66 as the bale grows within baling chamber 36.

Baling chamber 36 is open at the bottom to present a baling chamber inlet 80 defined generally between a starter roll 82 and idler roll 54. Although not illustrated in detail, it will be readily appreciated by one of ordinary skill in the art that the baler 20 preferably includes a pickup assembly 86 having a standard resilient rotary rake tine assembly for picking material 10 up off of the ground as the baler 20 moves across the field and for delivering the crop material 10 into the baling chamber 36. Power for operating the pickup assembly 86 and other components of the baler 20 can be delivered by a drive line (not shown) associated with the tongue 26. A front end of such a drive line can be adapted for connection to a power takeoff shaft (not shown) of the towing vehicle with a gearbox (not shown) coupled with the various drives for the baler components in a conventional manner, as will be readily appreciated by one of ordinary skill in the art. Additionally, the round baler 20 also includes a bale wrapping mechanism which dispenses twine or other wrapping material for wrapping bales formed in the bale forming chamber as understood by one of ordinary skill in the art.

Thus, windrowed crop material 10 may be fed into the baler 20 by the pickup assembly 86 and moved to the chamber inlet 80 by augers 22 or other means and fed into the bottom of the open throat bale chamber 36. When in the bale chamber 36, the crop material 10 contacts the surface of the belt stretch 74 which is moving upward. The forming belts 66 may be driven by the upper 40 and lower 38 drive rolls so that the forming belts 66, 74 carry the crop material 10 to the top of the chamber 36 and the motion of the forming belts 66, 72 turns the crop material 10 downward against the starter roll 82 so that a core is started and begins to roll. The crop material 10 may be initially formed into a small bale 90 (shown in dashed lines in FIG. 1) within the baling chamber 36 and the process continued to form an enlarged bale 90′ of a desired size.

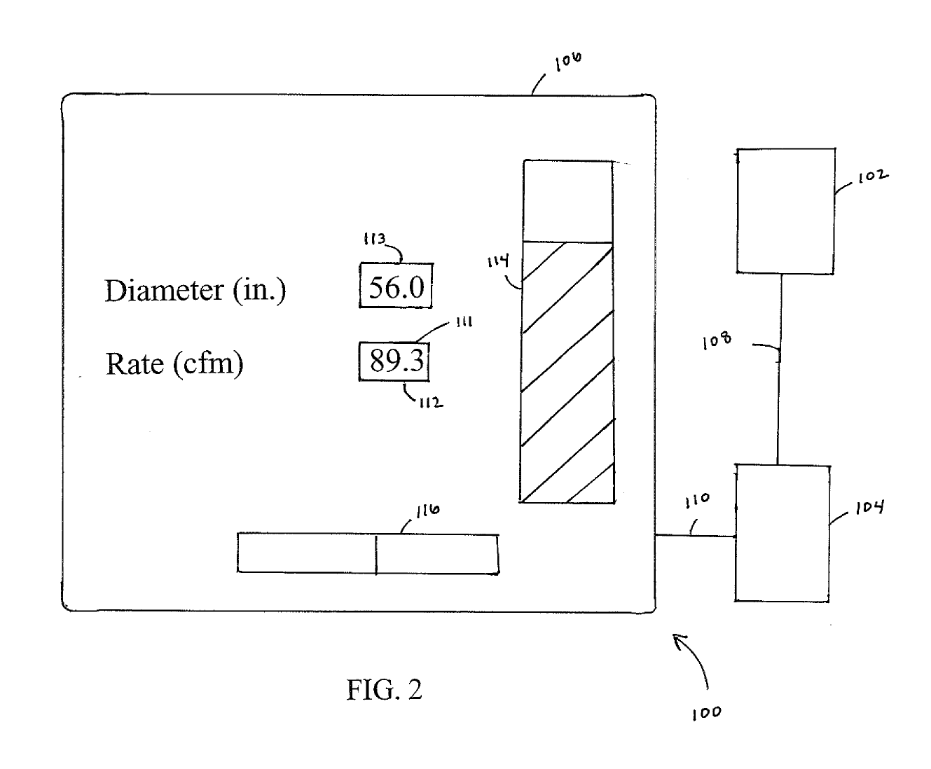

Turning also now to FIG. 2, according to the invention the bale forming mechanism 34 includes a volumetric baling rate monitor 100 that measures and displays the amount of crop material taken in by the round baler 20. The volumetric baling rate monitor 100 includes a bale size sensor 102 that measures information related to the size of the bale 90 as it is being formed in the baling chamber 36. A controller 104 receives this bale size information from the bale size sensor 102 and calculates the volumetric increase of the bale 90 in the baling chamber 36 over a desired period of time. The volumetric increase of the bale over the monitored time period is used to calculate a volumetric baling rate which is displayed on a user interface 106 which may be positioned in a cab of a vehicle (not shown) towing the baler 20. In one embodiment, the bale size sensor 102 is a rotation element coaxially mounted to one end of a mounting shaft 107 of one of the belt tensioning arms 70. The bale size sensor 102 produces output signals 108 corresponding to the rotational position of the belt tensioning arm 70, which position is representative of the size of the bale 90 being formed within the baling chamber 36. In one embodiment, the bale size sensor is a rotary hall-effect sensor and has a voltage output proportional to the radius of the bale. For example, the output signal 108 of the bale size sensor 102 has a range of 1-4V depending on the position of the belt tensioning arm 70. However, one skilled in the art will understand that other bale size measuring mechanisms, such as one measuring the take up of belt 66, may be used for the bale size sensors 102 or that the bale size sensor 102 may be mounted in other locations of the bale-forming mechanism 34 without departing from the scope of the invention.

The controller 104 receives output signals 108 from the bale size sensor 102 over a monitored period of time. A change in the output signals, representative of a change in the size of the bale 90 over the monitored period of time, is used to calculate a change in bale volume over that period of time. With the change in bale volume, the controller generates a signal 110 representative of the volumetric baling rate of the baler 20. The controller 104 may be any known processor or other control device and is programmed with a computer program comprising an ordered listing of executable instructions for implementing logical functions of the controller 104 that would be known in the art. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. As suitable controllers 104 are well known in the art, the controller 104 need not be described in further detail herein.

The user interface 106 receives the volumetric baling rate signals 110 from the controller 104 and displays a baling rate 111 in display 112. The bale diameter 113 may also be displayed on the user interface 106. One skilled in the art will understand that the display 112 can be a numerical representation in any units of volume per time, such as cubic feet per minute, or can be converted to an arbitrary scale, such as a number range from 1-10, a color scale, a bar scale or other scale, and shown as a graphical representation in display 114. Alternately, the display 112 may display an icon when the baling rate is above or below desired maximum or minimum values. In one embodiment, warning limits could be set that would warn the operator if the volumetric baling rate was above or below certain values. In one preferred embodiment, the user interface 106 includes a plurality of function keys 116 or other inputs that permit the operator to scroll through different functions to be shown on the user interface 106. The particular operation or function of each function key 116 may be determined by software and may be changed by the operator. For example, if the operator of the baler 20 desires that the maximum volumetric baling rate be 100 cfm based on the capacity of the baler 20 and the type and condition of crop, he could set that value in using the function keys 116 on the user interface 106. Then if the volumetric baling rate rose above 100, the user interface 106 would display an icon, sound a beep, change the color of a bar graph or numerical display or other warning signal to alert the operator.

By way of explanation, in one example the bale size sensor 102 sends output signals 108 to the controller 104 that show that the diameter of the bale 90 being formed in the baling chamber 36 grows from 55.0 inches (139.7 cm) to 56.0 inches (142.2 cm) over a two-second time interval. For a baling chamber 36 that is 5.0 feet (1.52 m) wide, the controller 104 calculates that the bale 90 increased in volume by 3.02 cubic feet (0.35 cubic meters) with a baling rate of 90.8 ft³/minute (CFM) (2.6 m³/minute). The volumetric rate signal 110 is sent to the user interface 106 to provide baling rate information to the operator of the baler 20. However, if the amount of cut crop in the windrow gets lighter in a portion of the field and the bale grows from 55.0 to 55.4 inches in two seconds, the controller 104 calculates that the baling rate is 36.1 CFM (1.02 m³/minute). Of course, the values and the size of the baling chamber 36 are for example purposes only and are not meant to be limiting. The operator of the baler 20 can use the baling rate information provided in display 112 and/or 114 and the feeding capacity of the baler 20 for the field conditions to adjust the speed of the vehicle towing the baler 20 to improve baling efficiency.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A round baler for use in baling crops, the round baler comprising a bale forming mechanism that forms a bale in a baling chamber of the round baler and a volumetric baling rate monitor that measures and displays the amount of crop material taken in by the round baler, the volumetric baling rate monitor comprising:
a bale size sensor that generates a signal representative of a measured size of the bale in the baling chamber;
a controller that receives said bale size signal from the bale size sensor over a desired period of time and calculates a volumetric baling rate from an increase in the measured size of the bale in the baling chamber over said period of time; and
a user interface that displays said volumetric baling rate of the baler.

2. The round baler of claim 1 wherein the bale-forming mechanism comprises at least one bale-forming belt and at least one belt tensioning arm configured to maintain tension in said bale-forming belt, and wherein the bale size sensor is connected to said belt tensioning arm.

3. The round baler of claim 2 wherein the bale size sensor is coaxially mounted to a mounting shaft of said belt tensioning arm.

4. The round baler of claim 2 wherein bale size sensor produces an output signal corresponding to the rotational position of said belt tensioning arm, which position is representative of the size of a bale being formed within the baling chamber.

5. The round baler of claim 1 wherein the user interface displays a numerical representation of the volumetric baling rate in units of volume per time.

6. The round baler of claim 1 wherein the user interface displays a representation of the volumetric baling rate using an arbitrary scale selected from the group consisting of a number range, a color scale and a bar scale.

7. The round baler of claim 1 wherein the user interface displays an icon when the volumetric baling rate is above a desired maximum value.

8. The round baler of claim 1 wherein the user interface displays an icon when the volumetric baling rate is below a desired minimum value.
